(19) United States
(12) Patent Application Publication
(10) Pub. No.: US 2019/0217535 A1
(43) Pub. Date: Jul. 18, 2019

(54) MULTISIZE PRINTING MATERIAL FOR ELECTROPHOTOGRAPHIC ADDITIVE MANUFACTURING

(71) Applicant: XEROX CORPORATION, Norwalk, CT (US)

(72) Inventors: Michael F. Zona, Webster, NY (US); William J. Nowak, Webster, NY (US); Jorge A. Alvarez, Webster, NY (US); Paul J. McConville, Webster, NY (US); Robert A. Clark, Williamson, NY (US)

(21) Appl. No.: 16/366,298

(22) Filed: Mar. 27, 2019

Related U.S. Application Data
(62) Division of application No. 15/194,419, filed on Jun. 27, 2016.

(51) Int. Cl. B29C 64/153; B29C 64/223; B29C 64/241; G03G 15/22; G03G 15/00; B33Y 40/00; B33Y 10/00; B29C 64/40; B29C 64/357; B33Y 30/00

(52) U.S. Cl. CPC B29C 64/153; B29C 64/223; B29C 64/241; G03G 15/224; B33Y 30/00; B33Y 40/00; B33Y 10/00; B29C 64/40; B29C 64/357; G03G 15/00

(57) ABSTRACT

A method of additive manufacturing includes forming a plurality of build layers, each of the plurality of build layers formed by transferring a first build material having a first particle size to form a first build material and transferring a second build material on the first build material to form one of the plurality of build layers, a particle size of the second build material is smaller than the first build material and each transfer step is performed by a xerographic engine. Each transfer step is involves transfer to a conveyor which can take the form of a belt or drum.

### BACKGROUND

The present disclosure relates to electrophotography. In particular, the present disclosure relates to the use of electrophotography in additive manufacturing (3D printing).

Current powder materials used in additive manufacturing (3D printing) with electrophotographic (EP) engines, have average particle sizes from about 11 to about 50 microns. One method of additive manufacturing assembles parts with successive layers by transfusion of each layer on top of one another using heat and pressure. The “smoothness” and uniform thickness of each layer is important when trying to achieve tight tolerances for precision parts. Using the current particle size configurations voids and non-uniformity in the surface of the layers prevents smooth layer surface texture, leading to low part quality. Thus, there is a need to improve the materials and methods employed in additive manufacturing.

### SUMMARY

A method of additive manufacturing comprising forming a plurality of build layers, each of the plurality of build layers formed by transferring a first build material having a first particle size to a conveyor, and transferring a second build material on the first build material to form one of the plurality of build layers, wherein a particle size of the second build material is smaller than the first build material, and wherein each transfer step is performed by a xerographic engine.

An additive manufacturing system comprising a conveyor, a first xerographic engine configured to transfer a first build material, a second xerographic engine configured to transfer a second build material on the first build material, and a transfuse station configure to fuse the first build material and second build material, wherein a particle size of the second build material is smaller than the a particle size of the first build material, and wherein the second xerographic engine is configured to receive the first build material after it has been transferred by the first xerographic engine.

A method of additive manufacturing comprising forming a plurality of build layers, each of the plurality of build layers formed by: transferring a first build material having a particle size in a range from about 10 microns to about 20 microns to form a first build material and transferring a second build material having a particle size in a range from about 4 microns to about 8 microns on the first build material to form one of the plurality of build layers, wherein each transfer step is performed by a separate xerographic engine.

### BRIEF DESCRIPTION OF DRAWINGS

Various embodiments of the present disclosure will be described herein below with reference to the figures wherein:

FIG. 1 shows a diagram of the fusion of a layer (build or support) with homogenous particle size.

FIG. 2 shows a diagram of the fusion of a layer (build or support) with two different particle sizes, in accordance with embodiments herein.

FIG. 3 shows a diagram of an additive manufacturing system for 3D printing, in accordance with embodiments herein.

### DETAILED DESCRIPTION

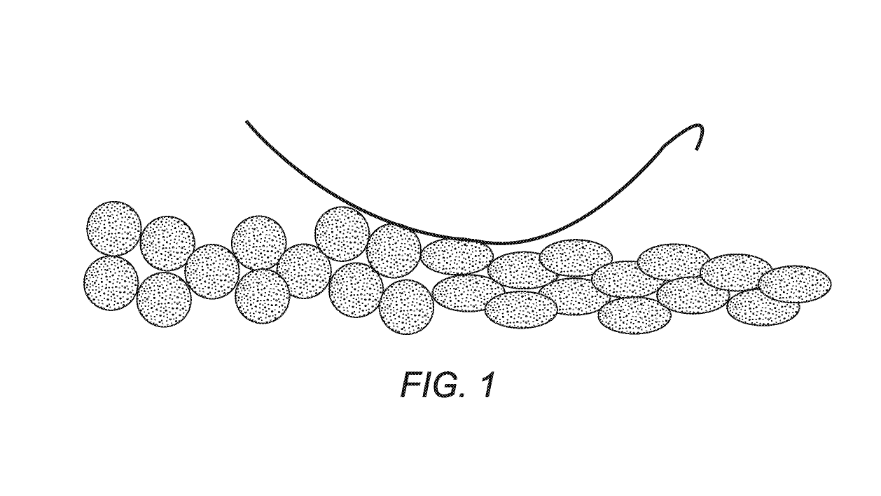

Embodiments herein employ electrophotography (EP) in additive manufacturing (3D printing) methods and systems as a means to print individual layers of a three dimensional part. In embodiments, systems may employ two xerographic engines, one for a build material and the other for a support material. Build materials comprise materials from which the final printed object is assembled. By contrast, support materials are temporary materials that are later removed and not part of the final printed object. Support materials are usually used to print overhang features and their use is necessitated by the bottom up layer by layer printing approach. Typical powdered materials for either the build or support material have average particle diameters ranging from about 11 to about 50 microns. To provide good development and transfer properties, the size distribution must be tight and stable to ensure uniform layer thickness. However, such large particle sizes create voids and non-uniformity in each layer as indicated in FIG. 1. To ensure tight part tolerances, each layer must have a very smooth surface and uniform layer thickness. During a transfuse step, each layer that is transferred to a belt in a xerographic engine is fused to preceding layers on a movable gantry typically using heat and pressure. While using larger size particles is good for providing layers with desired target thickness of about 30 to about 40 microns, the large particle size creates voids in the fused layer that lead to problems with dimensional stability, especially as more and more layers are added to the part. Moreover, each layer should be smooth to provide good fusing during the transfuse step of the proceeding layers. The larger size particles prevent presentation of a smooth surface for adherence of the next layer.

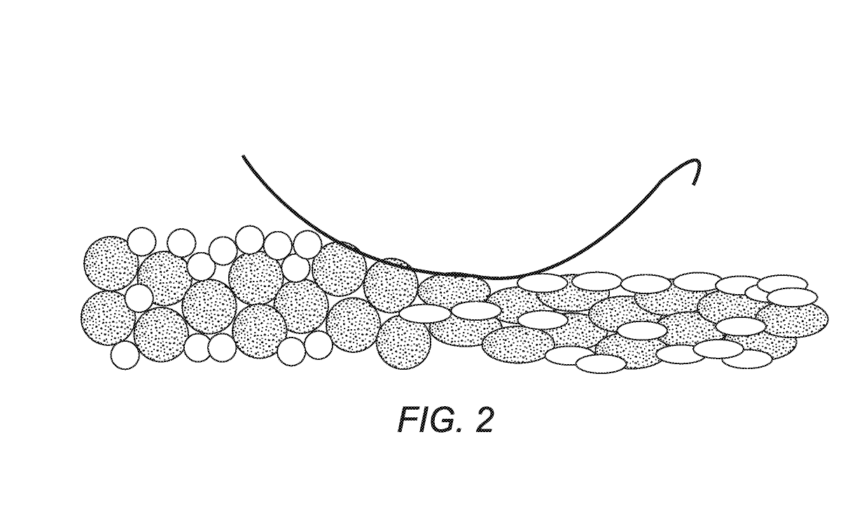

The voids shown in FIG. 1 as the empty spaces between the circles on the left (before fusion) and the empty space between ovals on the right (after fusion) indicate the issue with employing a single large particle size. Embodiments herein provide methods of additive manufacturing via electrophotography using two different (disparate) particle sizes in xerographic engines to provide a more uniform layer and provide a means to achieve smooth build layer surfaces for optimal transfusing. In particular embodiments, the methods provide a first particle having a particle size in a range from about 10 microns to about 20 microns to build a thick part layer and then applying a second particle having a particle size smaller than the first particle. In embodiments, the particle size of the second particle may be in a range from about 4 microns to about 10 microns. The second particle may advantageously fill in the inherent voids in the layer resulting in a very smooth finish on each layer, as shown in FIG. 2 in which the void space is substantially reduced. Employing two particles with disparate sizes results in a superior transfuse process thereby providing uniform parts with tight tolerances.

In order to introduce the smaller particle sizes discussed above, the additive manufacturing system may provide separate electrophotographic (EP) engines for small particle build material and small particle support materials. Thus, in embodiments, there provided additional electrophotographic engines that are disposed in subsequent engines to deliver the smaller particles. The additional engines can be tailored to provide optimal xerographic set points for good development and transfer of the smaller sized particles and may be set differently from the engine using the larger size particles. Thus, in embodiments, a systems and methods disclosed herein may employ four xerographic engines in total: one engine for the larger build material, one for the smaller build material, one for the larger support material, and one for the smaller build material.

As the smaller particles are transferred to each layer, they provide a means to “fill-in” the voids created by the larger particles used in the previous engine. As indicated in FIG. 2, during the transfuse step the layers that contain both large particles and small particles are more uniformly fused to each other and the surface of the layer is smooth so that adherence of subsequent layers is achieved more easily (including with less application of heat and/or pressure).

In embodiments, there are provided methods of additive manufacturing comprising forming a plurality of build layers, each of the plurality of build layers formed by transferring a first build material having a first particle size to form a first build material and transferring a second build material on the first build material to form one of the plurality of build layers, wherein a particle size of the second build material is smaller than the first build material, and wherein each transferring step is performed by a xerographic engine. The final transferred layer is then fused in a transfuse step to build a three dimensional part, layer by layer.

As used herein, “additive manufacturing” refers to a process that builds three-dimensional objects by adding layer-upon-layer of a build material. Although often associated with fused deposition modeling employing extrusion type techniques, embodiments herein employ xerographic techniques for each layer application. A further distinguishing feature of the present additive manufacturing methods and processes is the use of two different particles sizes of build material in each layer to improve the surface smoothness of each layer.

As used herein, “build material” refers to any material in particulate form suitable for additive manufacturing via xerography including a variety of thermoplastics or combinations of thermoplastics. Exemplary thermoplastics appropriate as build materials include, without limitation, Acrylonitrile butadiene styrene (ABS), Cross-linked polyethylene (PEX, XLPE), Ethylene vinyl acetate (EVA), Poly(methyl methacrylate) (PMMA), Polyacrylic acid (PAA), Polyamide (PA), Polybutylene (PB), Polybutylene terephthalate (PBT), Polycarbonate (PC), Polyetheretherketone (PEEK), Polyester (PEs), Polyethylene (PE), Polyethylene terephthalate (PET, PETE), Polyimide (PI)

Polylactic acid (PLA), Polyoxymethylene (POM), Polyphenyl ether (PPE), Polypropylene (PP), Polystyrene (PS), Polysulfone (PES), Polytetrafluoroethylene (PTFE), Polyurethane (PU), Polyvinyl chloride (PVC), Polyvinylidene chloride (PVDC), Styrene maleic anhydride (SMA), or Styrene-acrylonitrile (SAN).

In embodiments, the build material is provided in two different sizes and each size may be delivered by separate xerographic engines to optimize fusing conditions. In embodiments, the first particle size may have an effective particle diameter (approximating spherical shape) in a range from about 10 microns to about 40 microns, or from about 11 microns to about 30 microns, or from about 11 microns to about 20 microns. In embodiments, the second particle size may have an effective particle diameter in a range from about 3 microns to about 10 microns, or from 4 to about 8 microns, or about 4 microns to about 7 microns. Those skilled in the art, with the benefit of this disclosure, will appreciate that appropriate pairing of sizes for the first and second build materials may be optimized such that any pairing within the ranges may be employed.

In embodiments, the transferring steps for the first build material and second build material may be carried out in separate xerographic engines.

In embodiments, the methods disclosed herein may further comprise forming a support layer, the support layer formed by transferring a first support material having a first particle size to form a transferred first support material, and transferring a second support material on the transferred first support material to form the support layer, wherein a particle size of the second support material is smaller than the first support material, and wherein each transferring step for the first and second support material is performed by a xerographic engine. In embodiments, any given build layer may be formed on a support layer. In embodiments, any given support layer is formed on the build layer.

As used herein, a “support material” refers to a sacrificial material employed in additive manufacturing that serves as a scaffold to create overhanging features in a three-dimensional printed object. Support materials may be designed to melt away from the finished printed object or selectively dissolved in a solvent, allowing washing away of the support material leaving behind the printed three-dimensional object formed from the actual build material.

Support materials may be any appropriate material employed in the art including, without limitation, poloyglycolic acid (PGA) polymer, a thermoplastic copolymer comprising aromatic groups, (meth)acrylate-based ester groups, carboxylic acid groups, and anhydride groups, or any powder-based, soluble support material that is engineered for use in an electrophotography-based additive manufacturing system.

As used herein, a “build layer” refers to a single layer that comprises the fusion of at least two different particle sizes of build material. The two different size particles may be transferred by separate xerographic engines, with the first particle having the larger particle size being transferred first and then “gap-filling” by transfer of the second smaller particle size build material. By analogy, a “support layer” is similarly assembled from two different particle sizes (or distribution thereof) of support material.

In embodiments, a given build layer may have a thickness from about 20 microns to about 50 microns. In embodiments, the build layer has a thickness from about 30 microns to about 40 microns. In embodiments, the support layer has a thickness from about 20 to about 50 microns. In embodiments, the support layer has a thickness from about 30 microns to about 40 microns.

In embodiments, there are provided additive manufacturing systems comprising a first xerographic engine configured to transfer a first build material, and a second xerographic engine configured to transfer a second build material, wherein a particle size of the second build material is smaller than the a particle size of the first build material.

In embodiments, systems may further comprise a third xerographic engine configured to transfer a first support material. In embodiments, systems may further comprise a fourth xerographic engine configured to transfer a second support material, wherein the particle size of the second support material is smaller than the particle size of the first support material.

In embodiments, there are provided methods of additive manufacturing comprising forming a plurality of build layers, each of the plurality of build layers formed by transferring a first build material having a particle size in a range from about 10 microns to about 20 microns, and transferring a second build material having a particle size in a range from about 4 microns to about 8 microns on the first build material to form one of the plurality of build layers, wherein each transfer step is performed by a separate xerographic engine.

In embodiments, methods may further comprise forming a support layer, the support layer formed by transferring a first support material having a first particle size, and transferring a second support material on the support material to form the support layer, wherein a particle size of the second support material is smaller than the first support material, and wherein each transfer step for the first and second support material is performed by a xerographic engine.

In embodiments, each of the transferring steps for the first and second support materials may be performed by a separate xerographic engine.

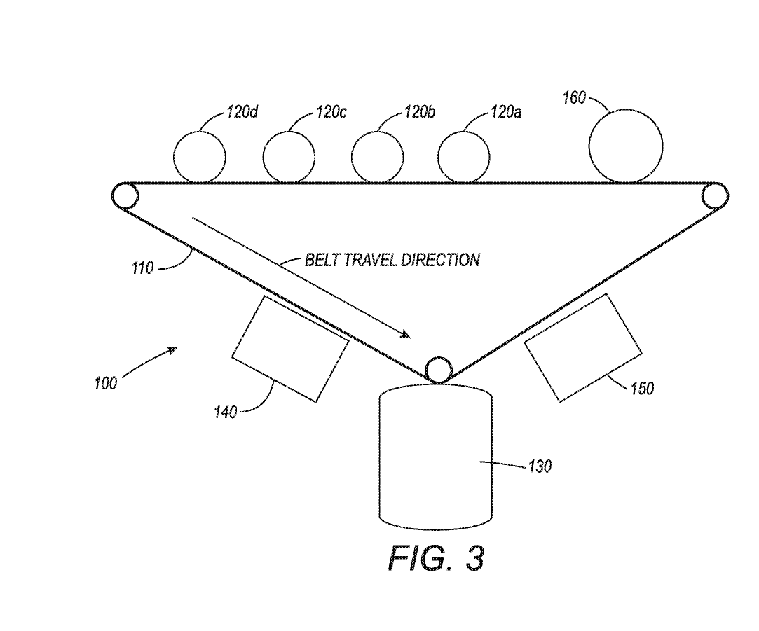

Referring now to FIG. 3, there is shown a process scheme 100 for implementation of embodiments disclosed herein. A large particle sized build material is transferred onto the transfuse belt 110 in the nip of the belt and electrophotographic (EP) engine 120a. As the belt rotates counter-clockwise, a smaller sized build material is transferred on top of the first build material at EP engine 120b. In areas of the article that require a support material for a given layer, EP engine 120c transfers a large size support material onto the transfer belt as is continues to rotate counter-clockwise. A smaller size support material in transferred on top of the large size material in EP engine 120d. When the belt exits EP station 120d, it has a completed part layer that comprises build material at two sizes, and optionally support material with two sizes (a layer may not need support material and only contain build material). It is unfused powder at this point. Once the belt delivers the powdered layer to a transfuse station 130, the layer is transferred off transfuse belt 110 to a build tray (not shown) within transfuse station 130 using heat and pressure. Prior to deliver at transfuse station 130, the transferred materials may be pre-heated at pre-heat station 140. The build tray within transfuse station 130 may be configured to move back and forth, as well as up and down, to accept subsequent layers in constructing an article. The first layer of the article is transfused to the build tray, the rest of the layers are transfused onto the previous layers. After a layer is transfused, transfuse belt 110 continues rotating under a cooling station 150 and then through a cleaning station 160 to remove any residual material that might have stuck to the belt.

Each EP engine 120a-d contains a development housing, photoreceptor, exposure device, charging device, and cleaning device. The set points within the engine are optimized in each engine based in the material type (build or support) and the size of the particles (large or small).

The following Examples are being submitted to illustrate embodiments of the present disclosure. These Examples are intended to be illustrative only and are not intended to limit the scope of the present disclosure. Also, parts and percentages are by weight unless otherwise indicated. As used herein, “room temperature” refers to a temperature of from about 20° C. to about 25° C.

1. A method of additive manufacturing comprising:
forming a plurality of build layers, each of the plurality of build layers formed by:
transferring a first build material having a first particle size to a conveyor; and
transferring a second build material on the first build material to form one of the plurality of build layers;
wherein a particle size of the second build material is smaller than the first build material; and
wherein each transfer step is performed by a xerographic engine.

2. The method of claim 1, further comprising fusing the transferred first and second build materials in a transfuse station.

3. The method of claim 1, wherein the conveyor is a belt or a drum.

4. The method of claim 1, wherein the transferring steps for the first build material and second build material are carried out in separate xerographic engines.

5. The method of claim 1, wherein the first build material has a particle size from about 10 microns to about 20 microns.

6. The method of claim 1, wherein the second build material has particle size from about 4 to about 8 microns.

7. The method of claim 1, further comprising forming one or more support layers, each of the one or more support layers formed by:
transferring a first support material having a first particle size to the conveyor; and
transferring a second support material on the first support material to form one of the one or more support layers;
wherein a particle size of the second support material is smaller than the first support material; and
wherein each transferring step for the first and second support material is performed by a xerographic engine.

8. The method of claim 5, wherein one of the plurality of build layers is formed on the support layer.

9. The method of claim 5, wherein one of the one or more support layers is formed on one of the plurality of build layers.

10. The method of claim 1, wherein each of the plurality of build layers has a thickness from about 20 microns to about 50 microns.

11. The method of claim 1, wherein each of the plurality of build layers has a thickness from about 30 microns to about 40 microns.

12. The method of claim 5, wherein each of the one or more support layers has a thickness from about 20 to about 50 microns.

13. The method of claim 5, wherein each of the one or more support layers has a thickness from about 30 microns to about 40 microns.

14. (canceled)

15. (canceled)

16. (canceled)

17. (canceled)

18. A method of additive manufacturing comprising:
forming a plurality of build layers, each of the plurality of build layers formed by:
transferring a first build material having a particle size in a range from about 10 microns to about 20 microns to form a first build material; and
transferring a second build material having a particle size in a range from about 4 microns to about 8 microns on the first build material to form one of the plurality of build layers;
wherein each transfer step is performed by a separate xerographic engine.

19. The method of claim 18, further comprising forming a support layer, the support layer formed by:
transferring a first support material having a first particle size to form a first support material; and
transferring a second support material on the first support material to form the support layer;
wherein a particle size of the second support material is smaller than the first support material; and
wherein each transfer step for the first and second support material is performed by a xerographic engine.

20. The method of claim 18, wherein each of the transferring steps for the first and second support materials is performed by a separate xerographic engine.
